(19) United States
(12) Patent Application Publication
(10) Pub. No.: US 2012/0036169 A1
(43) Pub. Date: Feb. 9, 2012

(54) Object identifier and common registry to support asynchronous checkpointing with audits

(76) Inventors: Ed Grinshpun, Freehold, NJ (US); Sameer Sharma, Holmdel, NJ (US)

(21) Appl. No.: 13/317,409

(22) Filed: Oct. 18, 2011

Related U.S. Application Data
(62) Division of application No. 12/318,851, filed on Jan. 9, 2009.

(51) Int. Cl. G06F 17/30

(52) U.S. Cl. 707/803; 707/802; 707/E17.044

(57) ABSTRACT

Example embodiments provide a method of identifying an application object that includes forming an assigned global persistent data record identifier (GPR ID) of the application object. The GPR ID includes a GPR type identifier, which identifies a cooperating application process (CAP) owner and a type of application object. The GPR ID further includes a GPR record identifier, which identifies an instance of the application object.

### PRIORITY STATEMENT

This application is a divisional, under 35 U.S.C. §§120, 121, of application Ser. No. 12/318,851 filed Jan. 9, 2009, the entire contents of which are herein incorporated by reference for all purposes.

### BACKGROUND

Telecommunication service providers typically measure equipment High Availability (HA) as a percentage of time per year that equipment provides full services. When calculating system downtime, service providers include hardware outages, software upgrades, software failures, etc. Typical requested equipment requirements to equipment vendors are: 99.999% (“5-nines” availability), which translates into about 0.001% system downtime per year (˜5.25 min per year) and 99.9999% (“6-nines” availability), which translates into about 0.0001% system downtime per year (˜31 sec per year). Typically for highly sensitive applications 1+1 redundancy (1 redundant (standby) equipment piece (device) for each active equipment piece (device)) is implemented in an attempt to protect the service provider from both hardware and software failures. To allow for cost savings, N+1 redundancy schemes are often also used (1 redundant (standby) for each N active). The standby equipment replicate the corresponding active equipment.

Real time embedded system software is organized as multiple Cooperating Application Processes (CAPs) each handling one of a number of functional components, such as: 1) Networking protocols, including, e.g., mobile IP (MIP), Layer 2 bridging (spanning tree protocol (STP), generic attribute registration protocol (GARP), GARP virtual LAN (VLAN) registration protocol (GVRP)), routing/multi-protocol label switching (MPLS), call processing, and mobility management, etc.; 2) Hardware forwarding plane management (e.g., interfaces, link state, switch fabric, flow setup, etc.); and 3) operations, administration, and maintenance (OA&M), e.g., configuration and fault/error management, etc. Each CAP is identified by a native identifier that is used to perform a CAP's application function.

FIG. 1A illustrates a portion of a known 1+1 redundancy network in which data is routed through various nodes A, B, C, and D, where each node includes various combinations of different CAPs. As shown, B may provide 1+1 redundancy for A and D may provide 1+1 redundancy for C. At any given time, either A or B is active, but not both. At any given time either C or D is active, but not both.

FIG. 1B illustrates a portion of a known N+1 redundancy network in which data is routed through various nodes A, B, C, and D, where each node includes various combinations of different CAPs. As shown, D provides N+1 redundancy for A, B and C. If A, B or C goes down, data traffic with go through D.

Dynamic object state information (e.g. calls, flows, interfaces, VLANs, routes, tunnels, mobility bindings, etc.), which is maintained by a software application, is distributed across multiple CAPs and across control and data planes. Each CAP manages and owns a subset of state information pertaining to the software application. The logistics of functional separation is typically dictated by product and software specific considerations. Data synchronization across CAPs is achieved via product-specific forms of Inter-Process Communication (IPC). The native identifier is used by CAPs as a relational database object key to identify an object in the Inter-Process Communication messages.

Software support is critical for achieving High Availability in embedded systems. Hardware redundancy without software support may lead to equipment “Cold Start” on failure during which services may be interrupted and all the service related dynamic persistent state data (e.g., related to active calls, routes, registrations, etc.) may be lost. The amount of time to restore service may include, a system reboot with saved configuration, re-establishment of neighbor relationships with network peers, re-establishment of active services, etc. Depending upon the amount of configuration needed, restoration often takes many minutes to completely restore services based on “Cold Start.” Various system availability models demonstrate that using only a cold start, a system can never achieve more than 4-nines HA (99.99% availability).

To achieve “6”-nines, HA typical software requirements include, sub 50 msec system downtime on CAP restart, software application warm start, and controlled equipment failover from Active to Standby nodes, and not more than 3-5 sec system downtime on software upgrades and uncontrolled equipment failover. The sub 50 msec requirements are often achieved via separation of the control and data planes. For example, the data plane would continue to forward traffic to support active services while the control plane would restart and synchronize the various applications.

### SUMMARY

Example embodiments are directed to an object identifier to support Asynchronous Checkpointing with Audits (ACWA).

Example embodiments include a method of forming a global persistent data record identifier (GPR ID) of an application object. The method includes generating a type identifier which identifies a cooperating application process (CAP) and a type of application object. A record identifier, which identifies an instance of the application object, is generated. The GPR ID is generated based on the type identifier and the record identifier.

Example embodiments also include a method of determining a GPR type Owner-Member Tree (OMT) hierarchy between CAPs, which are application object specific. The method includes identifying a GPR owner CAP and determining GPR member CAPs based on whether a CAP has any persistent data related to the application object. A GPR type OMT is then determined based on the owner CAP and the member CAPs.

At least one example embodiment includes an ACWA framework, comprising of a GPR type registry, storing specific application object types, a GPR manager, an audit library, a module manager and a configuration file management library. The GPR manager manages CAP GPR OMTs, an automated checkpointing library and a replication library. The audit library contains different types of automated audits and the module manager monitors system control procedures. The configuration file management library contains application configuration files.

Example embodiments include a method of activating an application. The method includes initializing the application and corresponding libraries, configuring application objects, populating object reference GPR OMTs to reference newly configured application objects and populating application specific data structures with dynamic persistent state data for the configured objects. The object data is checkpointed locally and the checkpointed object data is replicated at a standby module.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1A illustrates a portion of a known network with 1+1 redundancy;

FIG. 1B illustrates a portion of a known network with N+1 redundancy;

FIG. 2 illustrates an example embodiment of forming a global persistent data record identifier (GPR ID);

FIG. 3 illustrates an example embodiment of a GPR ID;

FIGS. 4A-4C illustrate example embodiments of GPR Owner-Member Trees (OMTs) with an object type; and

FIG. 5 illustrates an example embodiment of a main asynchronous checkpointing with audits (ACWA) framework, library components and ACWA automation functional flow.

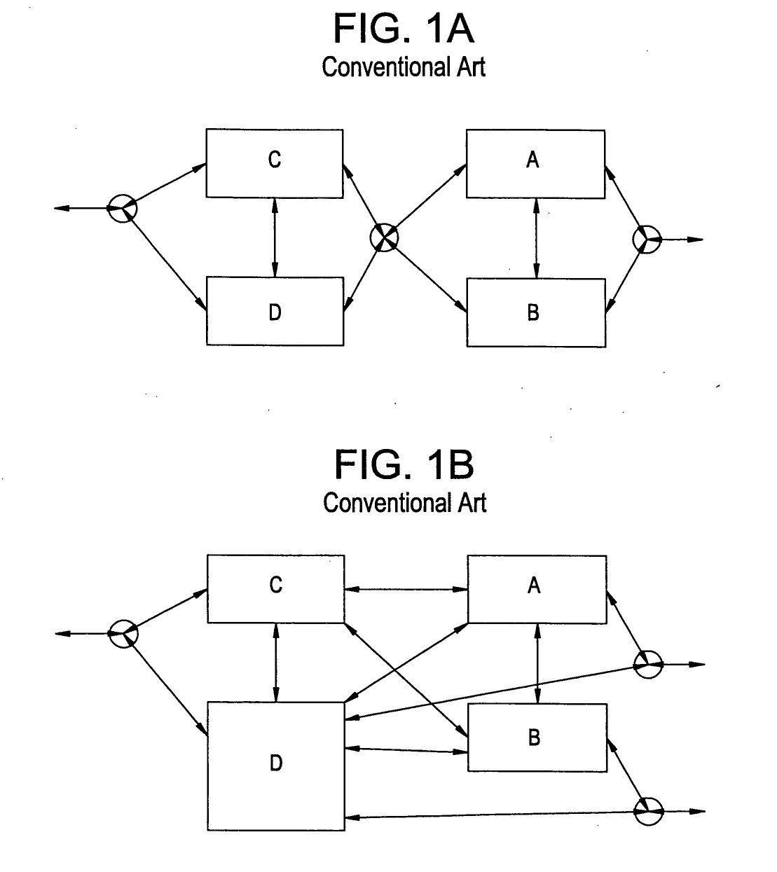

### DETAILED DESCRIPTION

Various example embodiments will now be described more fully with reference to the accompanying drawings in which some example embodiments are illustrated. In the drawings, the thicknesses of layers and regions may be exaggerated for clarity.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, e.g., “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the present invention and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements or control nodes (e.g., a scheduler located at a base station or Node B). Such existing hardware may include one or more digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

Example embodiments are directed to an object reference model using a global persistent data record identifier (GPR ID) as an object identifier to support Asynchronous Checkpointing with Audits (ACWA). As stated above, a CAP is created to perform an application function. Therefore, internal operations of the CAP that are based on the application function, utilizing the native identifier, should not change. The GPR ID allows ACWA services to be performed without affecting internal operations of the CAP that are based on the application function. Thus, the GPR ID may be used to perform ACWA services and the native identifier may be used to perform internal operations based on the application function.

The ACWA model operates under known embedded system assumptions. For example, persistent application data is distributed across multiple cooperating application processes (CAPs). Each CAP owns a subset of the data. Data synchronization for state information related to the same object(s) managed across different CAPs is performed via custom Inter-Process Communication (IPC) mechanisms.

In ACWA, each CAP may independently checkpoint dynamic persistent application state data. Checkpointing is a technique for inserting fault tolerance into computing systems by storing a snapshot of the current application state, and using the checkpointed data for restarting in case of failure. Checkpointing may include, e.g., checkpointing to local non-volatile memory storage and checkpointing to remote network storage.

Audits may be run to verify consistency of the checkpointed state data. For example, if a network has an equipment failover, then the CAP restores the application state data to the failed active node(s) based on an on demand audit of checkpointed state data at a corresponding standby node(s).

ACWA is further described in U.S. patent application Ser. No. unknown that is concurrently filed herewith and entitled “Asynchronous Checkpointing with Audits in High Availability Networks,” the entire contents of which are incorporated herein by reference.

In an example embodiment, the ACWA is combined with an Object-oriented Application Level Framework and an Infrastructure Library Layer. Automation of the ACWA operations includes the GPR ID. As discussed below, the GPR ID allows automation of common operations for checkpointing and audits without extra details for a dynamic object type and individual object registration, creation and deletion that may alter the internal operations of a CAP. Furthermore, object specifics may be hidden in a small number of dynamically registered common object handlers, while allowing full automation of common HA functions.

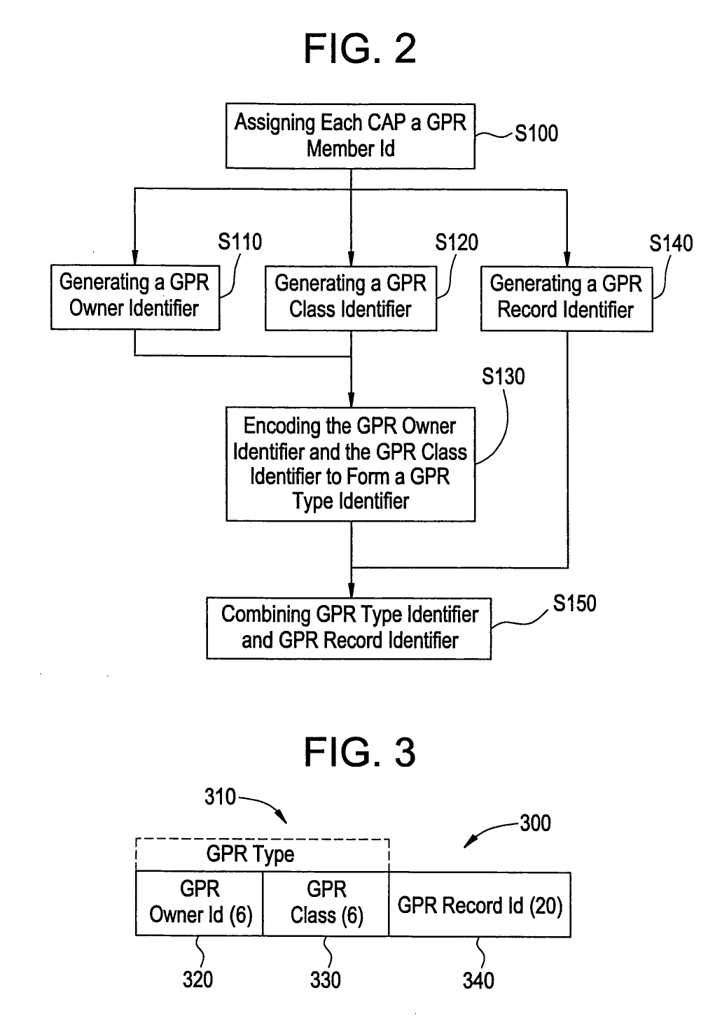

FIG. 2 illustrates an example embodiment of forming a GPR ID. At S100, each CAP in an embedded software system with HA support is assigned a GPR member identifier. The GPR member identifier may be statically assigned by software developers or system engineers designing the embedded system based on each CAP's native identifier, for example. Based on the GPR member identifier, a GPR owner identifier is generated by software developers or system engineers, for example, at S110.

At S120, a GPR class identifier is generated. The GPR class identifier may be generated in a similar manner as the GPR owner identifier. The GPR class identifier is a statically assigned number. The GPR class identifier identifies a type of object since a CAP may own different types of objects. A type of object may be an interface or a bridge among other types of objects.

The GPR owner identifier and the GPR class identifier are then encoded at S130 to form a GPR type identifier. For example, 6 most significant bits may correspond to the GPR owner identifier and next 6 bits may correspond to the GPR class identifier. Each CAP registers a GPR type identifier with a GPR registry for each object being handled by the CAP. The GPR registry controls checkpointing and automated audits. The GPR registry includes a GPR tree library and a GPR manager library API.

A GPR record identifier is generated at S140 by a CAP when an object instance is created. An instance might be physical or logical for an interface object type. Or, if the object type is a VLAN, then specific object instances might be two VLANs with VLAN id 100 and 200, respectively, for example. If there are ten logical interfaces, then there are ten possible GPR record identifier numbers in the same class. The GPR record identifier identifies an instance of the application object and may be based on the native identifier.

Each CAP handles a specific subset of object instance data for a given object type. The CAP managing/processing of this subset of object instance data for a given object type can be implemented via a set of CAP and object type-specific callback operations. If GPR type identifiers are the same, then the set of callback operations will be the same for a given CAP. The object callback operations, which are stored in the GPR registry library, may include the following:
1. pack( )—packing local dynamic data for a single object for checkpointing into a buffer;
2. packConfig( )—packing local configuration data for a single object for checkpointing into a buffer;
3. unpack( )—unpacking previously checkpointed local dynamic persistent data for a single object to populate local CAP data structures;
4. upackConfig( )—unpacking previously stored local configuration data (for a single object of this type) to populate local CAP data structures;
5. addRecords2GprCtxt( )—associate CAP native identifier with the CAP GPR ID assigned to the object;
6. processAudit( )—processing ACWA audit for a single object of a given type; and
7. processAuditFail( )—CAP-specific recovery on audit failure for a single object of a given type.

Other functions of HA can be implemented in a shared library. Examples of other functions are checkChildren( )to check whether all audit children respond to an audit before replying to an audit parent and migrateData( )to convert data on software upgrade from an old release format to a new release format.

At S150, the GPR type identifier and the GPR record identifier are combined to form the GPR ID.

Since the GPR owner identifier, the GPR class identifier and the GPR record identifier are created based on the native identifier, the GPR ID can be mapped to the native identifier.

FIG. 3 illustrates an example embodiment of a GPR ID 300 formed from the process of FIG. 2. The GPR ID 300 includes a GPR type identifier 310. The GPR type identifier 310 includes a GPR owner identifier 320 and a GPR class identifier 330. The GPR ID 300 further includes a GPR record identifier 340.

As shown in FIG. 3, the GPR ID 300 is shown to be encoded as a thirty-two bit number. The GPR owner identifier 320 is six bits, the GPR class identifier 330 is six bits and the GPR record identifier 340 is twenty bits. However, it should be understood that the GPR ID 300, GPR owner identifier 320, GPR class identifier 330 and GPR record identifier 340 may be any number of bits. For example, the GPR ID size may be based on the number of application object types.

Automated audits are performed by an audit library for registered object types across registered CAPs that manipulate distributed data. For automated audit purposes, the GPR ID allows the ACWA to use a GPR Owner-Member Tree (OMT) hierarchy between CAPs. The hierarchy may be determined by system engineers/developers and implemented via static registration.

A GPR OMT includes a parent CAP and children CAPs. Each CAP, for each GPR type it handles, registers whether it is a GPR owner and/or child and its immediate children/parents (if any) in the OMT hierarchy as part of registration for ACWA services, as will be described in more detail below. The relationship is stored in the GPR registry.

Audit messages traverse the GPR OMT in the direction from a parent CAP to its children CAPs. GPR OMT hierarchy is application/object type specific and is defined per object type when a CAP registers for ACWA services such as checkpointing, replication and auditing.

The GPR type is typically associated with an object type, for example, a VLAN, a bridge or a port. If there is provisional/configuration data associated with the object type, the GPR owner is a CAP that “owns” the provisional/configuration data. For example, the CAP that stores and manipulates a Management Information Base (MIB) for the object type is a GPR owner for that GPR type. The MIB uses objects to manage network devices.

If there is no provisional data, the GPR owner is a CAP that first creates an individual object of the object type and triggers an audit for that object type towards other CAPs. Other CAPs are chosen to be members of the GPR OMT depending upon whether they hold any persistent or auditable data relevant to that object. The parent-child hierarchy of a given GPR type may follow logic of the application function utilizing the native identifier of a CAP and IPC-based synchronization. The child-parent OMT relationship is established as part of a CAP registering object types it owns for ACWA services. The child-parent relationship is stored in the GPR registry.

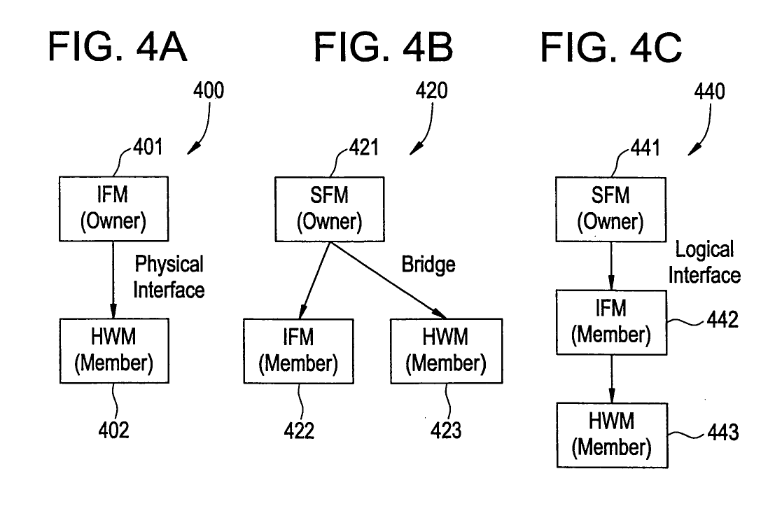

FIGS. 4A-4C illustrate example embodiments of GPR OMTs with an object type. FIG. 4A illustrates an example GPR OMT 400 for a Physical Interface GPR type. As shown, an Interface Manager and Networking protocol (IFM) CAP 401 is the GPR owner and a Hardware Manager (HWM) CAP 402 is a GPR member and a child of the IFM CAP 401.

FIG. 4B illustrates an example GPR OMT 420 for a Bridge GPR type. As shown, a Services and Flow Management (SFM) CAP 421 is the GPR owner. An IFM CAP 422 and an HWM CAP 423 are both GPR members and children of the SFM CAP 421.

FIG. 4C illustrates an example GPR OMT 440 having a multiple level hierarchy for a Logical Interface GPR type. An SFM CAP 441 is a GPR owner. An IFM CAP 442 is a first level GPR member and a child of the SFM CAP 441. An HWM 443 is a second level GPR member and a child of the IFM CAP 442.

As stated above, the GPR type identifier is associated with a specific object type. A GPR type registry contains object-specific information that is needed for automation of generic operations. For example, the GPR type registry contains CAP-specific rules to pack persistent data for checkpointing, size of packed record, whether CAP is a GPR owner or member, which CAP is a child in the OMT hierarchy and other rules.

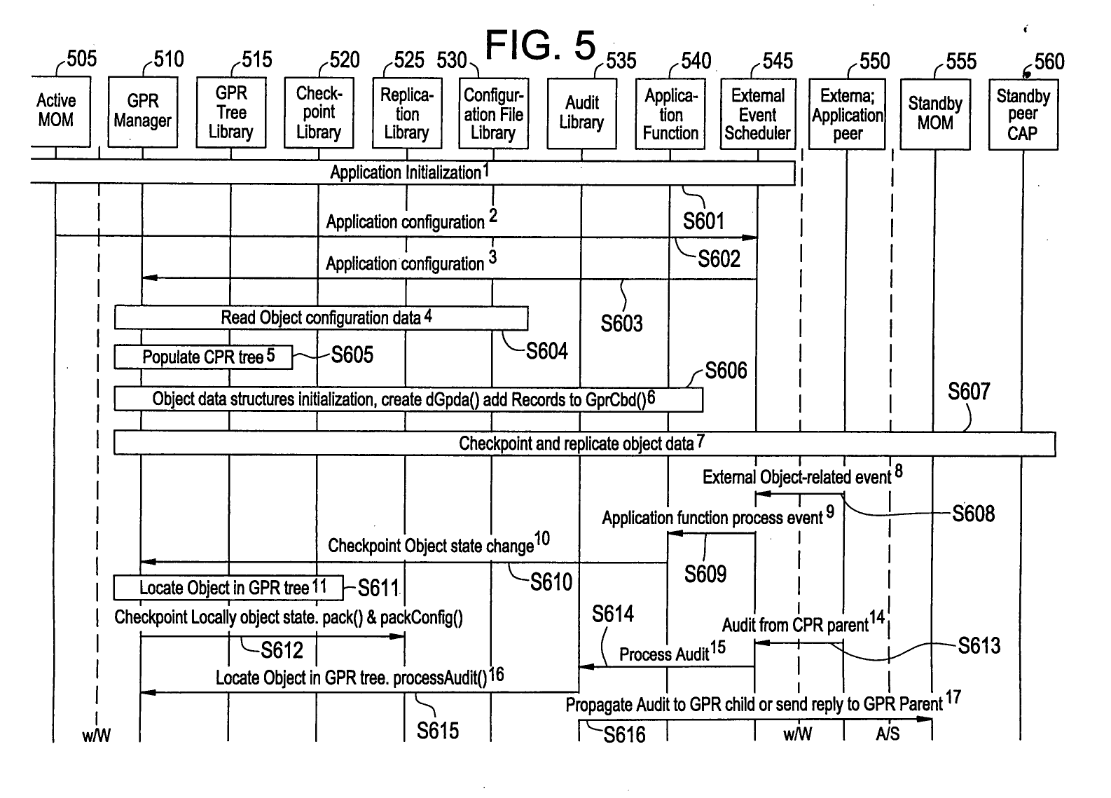

FIG. 5 illustrates an example ACWA framework, library components and ACWA automation functional flow in which a GPR ID is created at initialization. As shown, the ACWA framework includes an active module manager (MOM) 505, a GPR manager library API 510, a configuration file management library 530, an audit library 535, an application function 540, an external event scheduler 545, an external application peer 550, a standby MOM 555 and a standby peer CAP 560.

The GPR manager library API 510 includes a GPR tree library 515, an automated checkpoint library 520 and a replication library 525. A GPR registry may be formed with the GPR manager library API 510 and the GPR tree library 515. The GPR manager library API 510 performs all operations and the GPR tree library 515 manages the storage of registry components.

When an object instance is created, the GPR tree library 515 references application specific objects for each CAP based on addRecords2GprCtxt( ), which establishes the reference. The automated checkpoint library 520 stores dynamic persistent data in shared memory and configuration data in non-volatile memory to support a zero service downtime application process restart, a warm start and a cold start with a saved configuration from a previous checkpoint.

An active CAP includes, the GPR manager library API 510, the configuration file management library 530, the audit library 535, the application function 540 and the external event scheduler 545. The GPR manager library API 510, the configuration file management library 530 and the audit library 535 are for ACWA services whereas the application function 540 is for the application function utilizing the native identifier.

The role of the active CAP is to perform product functions whereas the role of the standby peer CAP 560 is to join the active CAP, receive bulk and incremental checkpointed data, and take over as an active CAP during a failover event by attaching itself to the replicated checkpointed state data. The standby peer CAP 560 may include the same features as illustrated in FIG. 5 for the active. However, for the sake of brevity and clarity, no further discussion will be provided.

The standby peer CAP 560 joins the active CAP by establishing a communication channel with the active CAP. As part of the join procedure, bulk replication of the Active CAP managed persistent data is performed. After the standby peer CAP 560 joins, incremental checkpointing initiated by the GPR manager library API 510 also triggers incremental peer-to-peer replication of the active CAP data being checkpointed to the standby peer CAP 560.

The replication library 525 is an automated incremental and bulk catch-up peer-to-peer replication library for registered CAPs. The standby peer CAP 560 joins the active CAP when the standby MOM 555 initializes. A 3-way handshake is formed when the standby peer CAP 560 sends a join message, the active CAP acknowledges the join message and the standby peer CAP 560 replies with another acknowledgement. As part of the 3-way handshake, checkpointed data is replicated from active to standby using a bulk catch-up replication procedure. Subsequent object checkpointing on an active side also triggers incremental replication via the 3-way handshake of the object data.

The audit library 535 performs automated audits using the GPR OMT hierarchy. Audits may be performed either periodically or during a forced recovery. Periodic (timer driven) automatic audits are performed in the background, meaning that they are not part of a CAP's main function, which is the foreground. Additionally, failure recovery that is driven by the active MOM 505 also triggers audits to check data consistency across the CAPs following failure recovery where loss of asynchronous events and IPC messages are expected for CAPs. Audits can be for distributed data across CAPs on active, or orphaned records on active. Orphaned records occur when the GPR owner CAP has deleted the object instance referenced by a particular GPR ID, however one or more GPR member CAPs continue to keep records associated with the object reference.

Audits can also be between CAP running and checkpointed data and active and standby CAPs. CAP running data may be the internal data that the CAP maintains as state information for the object instances. Furthermore, there is locally checkpointed data for the same objects that is used when the CAP restarts. Thus, audits between CAP running and checkpointed data are to verify consistency between the two data sets.

The active MOM 505 monitors the system. The monitoring could be performed in a variety of ways, for example, periodic IPC messages between the active MOM 505 and CAPs or receiving failure reports via IPC. Furthermore, the active MOM 505 controls the zero downtime application soft restart, recovery and software upgrade on active and standby modules. Housekeeping, such as proper resource allocation/deallocation and error handling, and controlled and uncontrolled failover triggers are performed by the active and standby MOMs 505 and 555.

Triggers for controlled failover may come from the operator or defined by policies on hardware failures when a communication channel between active and standby are still operational. Uncontrolled failover is triggered by the standby MOM 555 which is monitoring the active MOM 505. When the standby MOM 555 determines that the active MOM 505 is down, the standby MOM 555 triggers an uncontrolled failover.

An example embodiment of ACWA automation functional flow and an object instance created at initialization will now be described with reference to FIG. 5. As shown, a CAP and an ACWA library are first initialized at S601 (triggered by the Active MOM 505). The active MOM 505 instructs the CAP to start configuring the internal data structures based upon object configuration data (present for GPR owner CAP) and (if present) previously checkpointed dynamic object state data (GPR owner and GPR member CAP) at S602. A request to start configuring is passed to the GPR manager library API 510 which triggers ACWA library functions for a configuration phase at S603. At S604, the GPR manager library API 510 reads stored configuration data from a configuration file in the configuration file management library 530.

The GPR manager library API 510 then populates the GPR tree library 515 to reference newly configured CAP objects at S605. The CAP attaches itself to the configuration and previously checkpointed dynamic persistent data at S606 using the native identifier and creating an object instance. The unpackConfig( )for configuration data and unpack( )for dynamic persistent data callbacks, which are registered as part of registration for ACWA services, are invoked for each checkpointed object of the CAP. Internal application-specific data structures are populated with previously checkpointed state information and references to CAP-specific internal data structures are created in a GPR tree object which is operated by the GPR tree library 515. The CAP also populates its dynamic persistent (i.e., state) data for the referenced objects. A createGprId( )operation is called, thereby creating a GPR ID for object instance and registering the object instance for ACWA services.

The object data (e.g., configuration and dynamic persistent) is checkpointed locally and replicated to the standby peer CAP 560 at S607. In the example embodiment of FIG. 5, checkpointing is done automatically by the checkpoint library 520. The checkpoint can be triggered by a new object creation, for example, when a CAP unpacks previously checkpointed data and the CAP does not have any record of the data. The CAP then becomes fully active and functional.

The active and standby MOMs 505 and 555 coordinate initialization and configuration for all CAPS on a device, from both the active and standby side. The active MOM 505 controls the active side and the standby MOM 555 controls the standby side. Furthermore the active and standby MOMs 505 and 555 communicate via a peer-to-peer MOM-MOM communication channel established via a 3-way handshake similar to the 3-way handshake previously described.

In an embedded system application, CAPs are typically blocked in a main event loop waiting for events to be processes. At S608, the CAP receives an event. An event could be external (a signal or IPC message from another CAP, or an event received from network peers, for example) or internal (e.g., a timer event). The event is then passed to the CAP application function 440 for processing, at S609.

The CAP application function 440 is what the CAP needs to do in the embedded system. For example, the CAP application function for an HWM CAP is programming hardware. An IFM CAP's application function is to manage interface related state data and send networking protocol updates to its network peers. The ACWA functionality does not interfere with a CAP's application function. Steps S608 and S609 are native application CAP operations.

At the end of S609, an object instance is processed dynamically and the GPR ID is mapped to the native identifier. Since mapping of the object type in the context of a native identifier to a GPR type is performed statically, the GPR ID creation includes creating the GPR ID at S606 and assigning a GPR record identifier at the end of S609.

After processing the external event, the application function 540 uses the GPR manager library API 510 to checkpoint a modified state of the object(s) at S610. The GPR manager library API 510 exposes an ACWA automation API (application program interface) to the CAP. The GPR manager library API 510 then finds a corresponding ACWA object reference in the GPR tree library 515 at S611 by using the GPR ID as a key. At S612, the checkpoint library 520 checkpoints and replicates an object state change as a result of the processing. The CAP specific registered routines pack( )and packConfig( ) are called.

At a later time, a GPR parent or audit timer requests an audit, at S613. The event scheduler 545 invokes the audit library 535 at S614. At S615, the audit library 535 then invokes the GPR tree library 515 to locate an object reference and invoke the registered routine process processAudit( ). The object reference is located by using the GPR ID as a key in the GPR tree. The GPR tree contains references to all object instances registered for ACWA services. The audit library 535 then propagates the audit to any existing registered GPR children at S616. Any existing registered GPR children reply to the GPR audit parent. The GPR audit parent evaluates the replies and initiates a recovery when failure occurs.

While FIG. 5 illustrates object instance created at initialization, an object instance may also be created during run-time. The process is similar except that S606 replaces S610. Since the process is similar to that illustrated in FIG. 5, it will not be described in more detail for the sake of clarity and brevity.

Example embodiments of the present invention being thus described, it will be obvious that the same may be varied in many ways. Such variations are not to be regarded as a departure from the spirit and scope of the exemplary embodiments of the invention, and all such modifications as would be obvious to one skilled in the art are intended to be included within the scope of the invention.

What is claimed is:

1. An asynchronous checkpointing system with audits, comprising:
a global persistent record manager library storing object data corresponding to a cooperating application process, the global persistent record manager library being configured to manage global persistent record type trees, an automated checkpointing library, and a replication library;
an audit library containing different types of automated audits for object data within the cooperating application process;
a module manager monitoring system control procedures; and
a configuration file management library containing application configuration files to reconfigure the object data.

2. The system of claim 1, wherein the automated checkpointing library stores dynamic persistent data in shared memory and application configuration data in non-volatile memory.

3. The system of claim 2, wherein the stored dynamic persistent data and application configuration data supports at least one of, zero service downtime application process restart, warm start, and cold start.

4. The system of claim 1, wherein the replication library stores replicated checkpointed data.

5. The system of claim 1, wherein the audit library includes, audits for distributed data across cooperating application processes, audits between running and checkpointed data, audits between active and standby modules, and audits for orphaned records.

6. The system of claim 1 configured to use a global persistent data record identifier (GPR ID) including,
a type identifier, which identifies a cooperating application process owner and a class of application object types, and includes a owner identifier, and a class identifier, and
a record identifier, which identifies an instance of the application object.

7. A method of activating an application, comprising:
initializing the application and corresponding libraries;
configuring application objects;
populating global persistent record type trees to reference the configured application objects;
populating application data structures with dynamic persistent state data for the configured objects;
checkpointing object data locally; and
replicating checkpointed object data at a standby module.

8. The method of claim 7, further comprising:
receiving an external event related to an object;
passing the external event to at least one cooperating application process of the application;
checkpointing a modified state of the object data based on the external event; and
auditing an owner cooperating application process and member cooperating application processes based on at least one of an owner cooperating application process' request and a timer.

9. The method of claim 8, further comprising:
replicating object state change data at a standby device.
